(19) United States
(12) Patent Application Publication
(10) Pub. No.: US 2011/0110272 A1
(43) Pub. Date: May 12, 2011

(54) DEVICE AND METHOD FOR GENERATING TRAFFIC ENGINEERING TOPOLOGY

(75) Inventor: Byeongsik KIM, Daejeon (KR)

(73) Assignee: Electronics and Telecommunications Research Institute, Daejeon (KR)

(21) Appl. No.: 12/817,113

(22) Filed: Jun. 16, 2010

(30) Foreign Application Priority Data
Nov. 10, 2009 (KR) 10-2009-0108208

(51) Int. Cl. H04L 12/28

(52) U.S. Cl. 370/255

(57) ABSTRACT

A topology generating device of a network for transmitting/receiving a routing packet to/from at least one router receives a routing packet from the at least one router, determines whether the routing packet is a traffic engineering advertisement message, and generates traffic engineering topology by using the traffic engineering advertisement message when the routing packet is the traffic engineering advertisement message.

### CROSS-REFERENCE TO RELATED APPLICATION

This application claims priority to and the benefit of Korean Patent Application No. 10-2009-0108208 filed in the Korean Intellectual Property Office on Nov. 10, 2009, the entire contents of which are incorporated herein by reference.

### BACKGROUND OF THE INVENTION

(a) Field of the Invention

The present invention relates to a method and device for generating traffic engineering topology. More particularly, the present invention relates to a device and method for generating topology to which network traffic engineering information is applied.

(b) Description of the Related Art

A recent communication service aims at wideband and mobility, and it has been developed toward a digital convergence service that is a combination of communication, broadcasting, and Internet. This combined service is available through the network on which a wideband multimedia service guaranteeing high quality in the information communication environment generated by combination of wired/wireless broadcasting and communication is used.

A monitoring system for the above-noted network uses the simple network management protocol (SNMP) to collect a router's interface information, and generates the network's physical topology. When the network is configured in consideration of physical topology of the network, traffic flows at respective links are inaccurately applied to thereby cause imbalance of traffic flows and generate congestion.

Therefore, skills for generating physical topology of the network and topology to which accurate traffic engineering information is applied in the network are required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a device and method for generating traffic engineering topology to which traffic engineering information of the network is applied.

An exemplary embodiment of the present invention provides a method for generating traffic engineering topology in a topology generating device of a network for transmitting/receiving a routing packet to/from at least one router, including: receiving the routing packet from at least one router; determining whether the routing packet is a traffic engineering advertisement message; and generating traffic engineering topology by using the traffic engineering advertisement message when the routing packet is found to be a traffic engineering advertisement message.

Another embodiment of the present invention provides a device for generating topology of a network for transmitting/receiving a routing packet to/from at least one router, including: a routing packet processor for receiving the routing packet from the at least one router, determining whether the routing packet is a traffic engineering advertisement message, and sending the traffic engineering advertisement message; and a topology generator for, when the routing packet is a traffic engineering advertisement message, receiving the traffic engineering advertisement message from the routing packet processor, and generating traffic engineering topology by using the traffic engineering advertisement message.

### BRIEF DESCRIPTION OF THE DRAWINGS

FIG. 1 shows a network according to an exemplary embodiment of the present invention.

FIG. 2 shows a topology generating device according to an exemplary embodiment of the present invention.

FIG. 3 shows a flowchart of a method for a topology generating device according to an exemplary embodiment of the present invention to generate traffic engineering topology.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

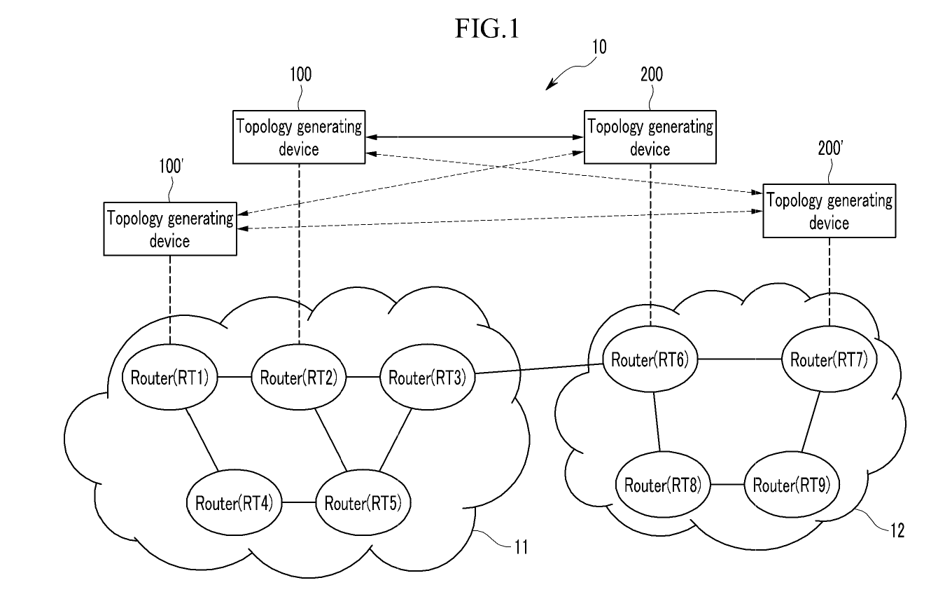

FIG. 1 shows a network according to an exemplary embodiment of the present invention.

As shown in FIG. 1, the network 10 includes topology generating devices 100, 100′, 200, and 200′ for generating traffic engineering topology, and a plurality of routers R11-R15 and R21-R24. Here, the network 10 may include at least one network, and it is assumed in the exemplary embodiment of the present invention that it includes a network 11 and a network 12.

The routers RT1-RT9 perform a routing function for traffic engineering by using a routing protocol. The link state routing protocols such as the open shortest path first-traffic engineering (OSPF-TE) or the intermediate system to intermediate system-traffic engineering (ISIS-TE) are used to perform a routing function for traffic engineering. The routers RT1-RT9 generate and advertise a traffic engineering advertisement message including traffic engineering information. Here, the traffic engineering information can be traffic engineering metrics allocated by a network manager and bandwidths allocated to the links. When the routers RT1-RT9 use the OSPF-TE link state routing protocol, they generate a link state advertisement (LSA) message with the traffic engineering advertisement message and advertise it, and when they use the ISIS-TE link state routing protocol, they generate a link state PDU (LSP) message with the traffic engineering advertisement message and advertise it. The routers RT1-RT9 store traffic engineering advertisement messages provided by other routers.

Further, the routers RT1-RT9 generate a hello packet as information for maintaining adjacency and transmit it to the adjacent nodes.

The topology generating devices 100, 100′, 200, and 200′ are randomly connected to routers RT1-RT9 to be listened to in the network 10. The topology generating devices 100, 100′, 200, and 200′ respectively receive a traffic engineering advertisement message from the randomly connected routers RT1-RT9. The topology generating devices 100, 100′, 200, and 200′ generate traffic engineering topology by using the traffic engineering advertisement message of the network.

The topology generating devices 100, 100′, 200, and 200′ share the stored traffic engineering advertisement message to maintain the traffic engineering advertisement message of the entire network 10. That is, in the normal case, the topology generating device 100 and the topology generating device 200 transmit the traffic engineering advertisement message and share it. However, in preparation for impossibility of operation under a specific condition, the topology generating device 100 shares the traffic engineering advertisement message with the topology generating device 200′ as well as the topology generating device 200, and the topology generating device 200 shares the traffic engineering advertisement message with the topology generating device 100′ as well as the topology generating device 100. Also, the topology generating device 100′ and the topology generating device 200′ share the traffic engineering advertisement message.

The respective configurations and functions of the topology generating devices 100, 100′, 200, and 200′ according to an exemplary embodiment of the present invention are the same, and hence, a configuration of a topology generating device and a topology generation method will now be described by exemplifying the topology generating device 100.

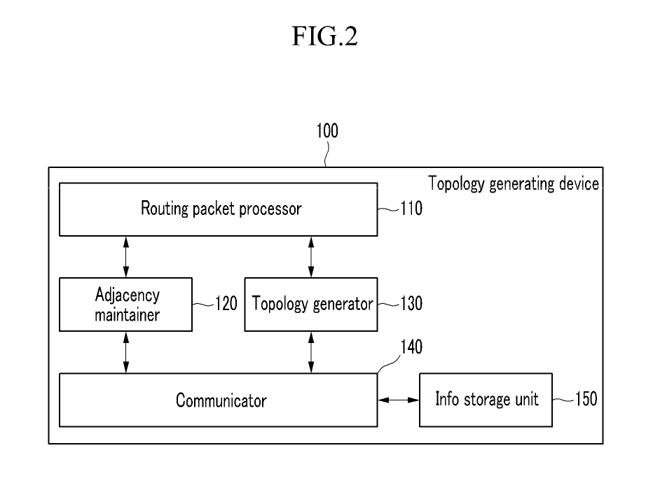

FIG. 2 shows a topology generating device according to an exemplary embodiment of the present invention.

As shown in FIG. 2, the topology generating device 100 includes a routing packet processor 110, an adjacency maintainer 120, a topology generator 130, a communicator 140, and an information storage unit 150.

The routing packet processor 110 receives a routing packet from a randomly selected router. The routing packet processor 110 determines whether the routing packet is transmitted according to the routing protocol. When the routing packet is found to be transmitted according to the routing protocol, the routing packet processor 110 determines whether the routing packet is a hello packet. When the routing packet is found to be a hello packet, the routing packet processor 110 sends the routing packet to the adjacency maintainer 120. When the routing packet is a traffic engineering advertisement message, the routing packet processor 110 sends the traffic engineering advertisement message to the topology generator 130.

When receiving the hello packet from the routing packet processor 110, the adjacency maintainer 120 drives a timer to use it as information for maintaining adjacency, and transmits the hello packet to the corresponding router having transmitted the routing packet so as to maintain adjacency through the communicator 140.

When receiving the traffic engineering advertisement message from the routing packet processor 110, the topology generator 130 applies a path calculation algorithm to the traffic engineering advertisement message to process information on the link state. The topology generator 130 generates traffic engineering topology by using information on the link state. The topology generator 130 stores the traffic engineering advertisement message in the information storage unit 150. Also, the topology generator 130 transmits the traffic engineering advertisement message to other topology generating devices 100′, 200, and 200′ of the network 10.

The communicator 140 performs communication so that the routing packet between the topology generating device 100 and the other topology generating devices 100′, 200, and 200′ may be transmitted/received.

The information storage unit 150 stores the traffic engineering advertisement message transmitted/received by the entire network 10 to generate traffic engineering information. The information storage unit 150 refers to the traffic engineering advertisement message to provide information when a request is given.

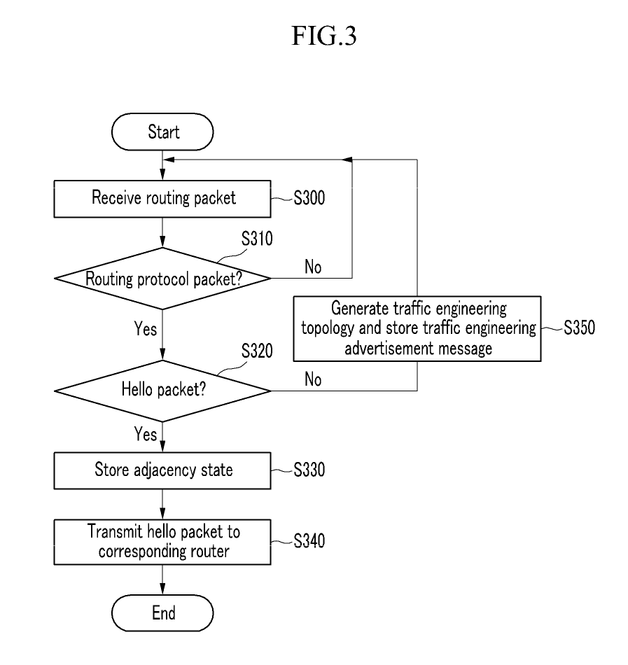

FIG. 3 shows a flowchart of a method for a topology generating device according to an exemplary embodiment of the present invention to generate traffic engineering topology.

Referring to FIG. 3, the routing packet processor 110 of the topology generating device 100 receives a routing packet from a randomly selected router (S300). The routing packet processor 110 determines whether the routing packet is transmitted according to the routing protocol (S310).

When the routing packet is found to be transmitted according to the routing protocol, the routing packet processor 110 determines whether the routing packet is a hello packet (S320). If not, the routing packet processor 110 receives a next routing packet.

When the routing packet is a hello packet, the routing packet processor 110 sends the routing packet to the adjacency maintainer 120 (S330). The adjacency maintainer 120 uses the hello packet as information for maintaining adjacency, and transmits the hello packet to the corresponding router having transmitted the routing packet so as to maintain adjacency (S340). In this instance, the routing packet processor 110 stands by so as to receive the next routing packet.

When the routing packet is a traffic engineering advertisement message, the routing packet processor 110 sends the traffic engineering advertisement message to the topology generator 130. The topology generator 130 uses the traffic engineering advertisement message to process information on the link state and generate traffic engineering topology. The topology generator 130 stores the traffic engineering advertisement message in the information storage unit 150 (S350).

Accordingly, the topology generating device according to an exemplary embodiment of the present invention uses traffic engineering information provided by the router to generate traffic engineering topology, and hence, more accurate traffic engineering topology can be generated compared to the case of applying the network's physical connection information. The network path can be more efficiently set, managed, and monitored by generating topology to which traffic engineering information is applied.

In addition, according to an embodiment of the present invention, when traffic engineering information to which traffic engineering information is applied is generated by using a routing listener, it becomes possible to generate topology to which accurate traffic engineering information is applied in addition to physical topology of the network.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for generating traffic engineering topology in a topology generating device of a network for transmitting/receiving a routing packet to/from at least one router, comprising:
receiving the routing packet from the at least one router;
determining whether the routing packet is a traffic engineering advertisement message; and
when the routing packet is found to be a traffic engineering advertisement message, generating traffic engineering topology by using the traffic engineering advertisement message.

2. The method of claim 1, wherein
the determining includes:
when the routing packet is a hello packet, maintaining adjacency by using the hello packet as information for maintaining adjacency; and
transmitting the hello packet to a corresponding router having transmitted the routing packet.

3. The method of claim 1, wherein
the generating of traffic engineering topology includes:
processing information on a link state of the network by applying a path calculation algorithm to the traffic engineering advertisement message; and
generating the traffic engineering topology by using the information on the link state.

4. The method of claim 1, further including:
storing the traffic engineering advertisement message; and
transmitting the traffic engineering advertisement message to another topology generating device of the network and sharing the same.

5. The method of claim 1, wherein
the traffic engineering advertisement message includes traffic engineering information.

6. A device for generating topology of a network for transmitting/receiving a routing packet to/from at least one router, comprising:
a routing packet processor for receiving the routing packet from the at least one router, determining whether the routing packet is a traffic engineering advertisement message, and sending the traffic engineering advertisement message; and
a topology generator for, when the routing packet is a traffic engineering advertisement message, receiving the traffic engineering advertisement message from the routing packet processor, and generating traffic engineering topology by using the traffic engineering advertisement message.

7. The device of claim 6, wherein
the routing packet processor sends a hello packet by determining whether the routing packet is the hello packet.

8. The device of claim 7, further including
an adjacency maintainer for, when the routing packet is a hello packet, receiving the hello packet from the routing packet processor, maintaining adjacency by using the hello packet, and generating and sending a hello packet for maintaining the adjacency.

9. The device of claim 6, wherein
the topology generator processes information on a link state of the network by applying a path calculation algorithm to the traffic engineering advertisement message, and generates the traffic engineering topology by using the information on the link state.

10. The device of claim 6, wherein
the topology generator transmits the traffic engineering advertisement message to another topology generating device of the network and shares the same therewith.

11. The device of claim 6, wherein
the traffic engineering advertisement message includes traffic engineering information.
